(19) United States
(12) Patent Application Publication
(10) Pub. No.: US 2010/0078182 A1
(43) Pub. Date: Apr. 1, 2010

(54) DEVICE FOR GENERATING AND STORING ELECTRICAL OR MECHANICAL ENERGY, AND METHOD FOR FIRE AVOIDANCE

(76) Inventors: Ulrich Alkemade, Leonberg (DE); Florian Wahl, Lohr (DE); Martin Holger Koenigsmann, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/512,267

(22) Filed: Jul. 30, 2009

(30) Foreign Application Priority Data
Jul. 30, 2008 (DE) 10 2008 040 863.8

(51) Int. Cl. A62C 3/06

(52) U.S. Cl. 169/45; 169/66; 169/11

(57) ABSTRACT

A device for generating or storing electrical or mechanical energy is described, having an encapsulation in which at least one element of the device serving to generate or store electrical or mechanical energy, or a fuel tank, is positioned, and having a container for a flame-retardant substance. According to the invention, it is provided that the substance stored in the container releases a flame-retardant component if need be.

### CROSS-REFERENCE TO RELATED APPLICATION

This application is based on German Patent Application 10 2008 040 863.8 filed Jul. 30, 2008.

### BACKGROUND OF THE INVENTION

1. Field of the Invention

The invention relates to a device for generating or storing electrical or mechanical energy and to a method for fire avoidance in such a device as generically defined by the preambles to the independent claims.

2. Description of the Prior Art

Both fuel cells and powerful rechargeable batteries are gaining ever-increasing importance for both mobile and stationary purposes.

As a rule, fuel cells are operated with a gaseous combustible energy carrier, such as hydrogen. This involves the danger that hydrogen and air form combustible gas mixtures that under certain circumstances are even explosive. In this respect it is known from German Patent Disclosure DE 103 36 326 A1 to provide a fuel cell system with a safety device, which stores a noncombustible substance with which an encapsulation that has the fuel cell can be flooded and rinsed if unwanted gases escape.

Particularly in powerful rechargeable batteries or regular batteries, it is also known that under certain circumstances so-called “thermal runaway” can occur, in which the rechargeable battery within an extremely short time heats up so severely that a fire can occur. For particular types of regular battery or rechargeable battery, the limit temperature at which the flammability limit of the various affected materials is exceeded is known.

### OBJECT AND SUMMARY OF THE INVENTION

It is the object of the present invention to furnish a device for generating or storing electrical or mechanical energy which even in the case of a defect is effectively protected against a fire.

The object on which the invention is based is advantageously attained by a device and a method having the definitive characteristics of the independent claims.

This is due to the fact that components of the device that are threatened by fire, such as an element of the device serving to generate or store electrical or mechanical energy and/or a fuel tank, are positioned inside an encapsulation. In this way, the entry of oxygen from the air, which would promote a fire, is initially impeded. Moreover, the device includes a container for a flame-retardant substance, and in the event of fire this substance releases a flame-retardant component. The advantage of using such a substance is that it is not the flame-retardant component itself that has to be stored but rather it can be stored in the form of a precursor stage. In such a case, substantially smaller storage volumes as a rule suffice.

For instance, it is advantageous if the substance that releases a flame-retardant component is a hydrogen carbonate, a triazine, or an azide, optionally with the addition of passivating substances, that is, substances that regulate the thermal decomposition of the components. These compounds are solids which on being heated give off large quantities of carbon dioxide and/or nitrogen, which in turn are flame-retardant because they positively displace oxygen.

A second advantageous possibility is to use solid or liquid carbon dioxide and/or liquid nitrogen as the substance that releases a flame-retardant component. In this case as well, markedly smaller storage volumes can be achieved than when carbon dioxide and/or nitrogen is stored in gaseous form.

A further advantageous embodiment comprises using microcapsules as the substance that releases a flame-retardant component, which are in turn filled with carbon dioxide and/or nitrogen under pressure. As soon as the outer shell of the microcapsules is thermally or chemically and/or mechanically destroyed, the gases under pressure, carbon dioxide and/or nitrogen, stored in the interior of the microcapsules is released and have a fire-retardant effect.

In an especially preferred embodiment of the present invention, the container is in communication by way of a bursting disk that is in contact with the interior of the encapsulation and/or via a metering valve. In this way, passive fireproofing can be attained, since if the pressure increases in the interior of the encapsulation or container, the release of the flame-retardant component automatically ensues. A further advantageous possibility is to provide a sensor, preferably in the interior of the encapsulation, for detecting conflagration gases and/or the temperature, so that the release of conflagration gases and/or an unwanted change in the internal temperature is detected early, and the release of flame-retardant substances can be initiated. To that end, the container may for instance include a heating element.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 is a schematic illustration of the device of the invention in a first exemplary embodiment; and

FIG. 2 is a schematic illustration of the device according to the invention in a second exemplary embodiment.

### DESCRIPTION OF THE PREFERRED EMBODIMENTS

The device according to the invention for generating or storing electrical or mechanical energy may be embodied for instance as a fuel cell system. It is provided that at least some of the components of the fuel cell system that are potentially threatened with fire are disposed in an encapsulation, to prevent the entry of oxygen from the air and/or to prevent a possible source of a fire from spreading to other components of the fuel cell system. Examples of such fire-threatened components of the fuel cell system are the fuel cell stack, fuel tanks, or a reformer provided in the fuel cell system. They can each be separately encapsulated, or they can be provided in a single common encapsulation. The encapsulation itself is preferably embodied in airtight and/or temperature-proof form.

Alternatively, the device of the invention can also be embodied as a regular battery or as a rechargeable battery. In this case, the battery or rechargeable battery is itself preferably disposed inside a suitable encapsulation.

In a further alternative, the device of the invention includes an internal combustion engine. In this case as well, components of the device that are potentially threatened with fire, such as the engine itself or a possible fuel tank, are embodied in suitably encapsulated form. It is understood that devices which connect a plurality of the aforementioned alternative embodiments to one another, such as hybrid systems, are also a subject of the invention.

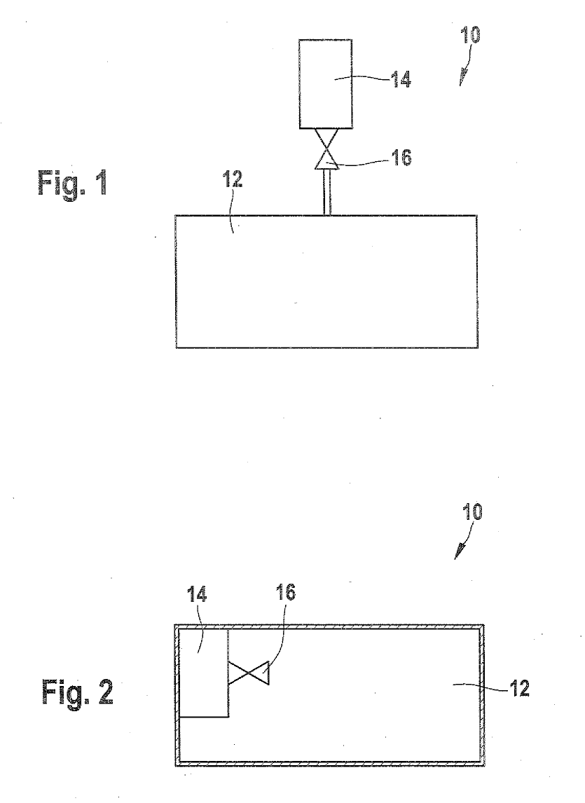

In FIG. 1, a device 10 of the invention for generating or storing electrical or mechanical energy is shown schematically. The device 10 includes one encapsulation 12, for instance, in which potentially fire-threatened components of the device 10 are located. Other peripheral components, such as filters, pumps, supply lines and outgoing lines, are not shown. A container 14 in which a substance is stored which is capable of releasing a flame-retardant component if need be is in contact with the encapsulation 12. The contact 14 is in fluidic contact with the encapsulation 12 via a metering valve 16.

Alternatively, the container 14 is positioned in physical contact with the encapsulation 12 and is separated from its interior, for instance by a bursting disk. The container 14 may for instance be positioned on the outer shell of the encapsulation 12 in stationary fashion, for instance by welding or flanging. Both the metering valve 16 and the bursting disk have the property that at a defined temperature and/or a defined pressure, they enable passage, and thus the interior of the container 14 comes into contact with the interior of the encapsulation 12. The corresponding temperature and pressure for opening up the communication between the container 14 and the encapsulation 12 are selected such that this communication preferably happens only in the event of fire, and the flame-retardant component released by the substance stored in the container 14 is capable of extinguishing possible fires inside the encapsulation 12.

The shape and volume of the encapsulation 12 is preferably selected such that the smallest possible air space remains between the system components of the device of the invention that are provided inside the encapsulation 12 and the wall of the encapsulation 12. In this case, even a slight amount of a released flame-retardant component suffices to extinguish and/or smother a possible fire.

The substance stored in the container 14 is selected such that in the event of an elevated temperature, it releases a flame-retardant component. In the container 14, this creates an overpressure that for instance causes the opening mechanism, in the form of the metering valve 16 and/or a bursting disk, to open. To assure this, the container 14 and/or a suitable fluidic communication between the container 14 and the encapsulation 12 is for instance embodied of a material that is a good thermal conductor, such as a suitable metal, preferably copper. It is also advantageous if the container 14 and the encapsulation 12 have as small as possible a spacing between them. In a further embodiment, so-called “heat pipes” for heat transfer between the encapsulation 12 and the container 14 are used.

As the substance stored in the container 14 which when heat is supplied releases a flame-retardant component, hydrogen carbonates, triazines or azides are for instance suitable. Suitable hydrogen carbonates release carbon dioxide, while triazines and azides among other things break down into nitrogen. To prevent a dynamic decomposition of the stored substance, passivating compounds can additionally be added, that is, compounds such as silica gel that moderate the course of the reaction.

The use of alkali and alkaline earth hydrogen carbonates is preferable, such as lithium, sodium or potassium hydrogen carbonate, as well as magnesium, calcium, strontium and barium hydrogen carbonate. The various hydrogen carbonates break down at different temperatures and in the process release carbon dioxide.

This makes it possible to adapt the substance stored in the container 14 to the applicable flammability limit of the potentially fire-threatened components of the device to be protected. In rechargeable batteries, for instance, the effect of so-called “thermal runaway” is known, in which overheating of the rechargeable battery occurs that becomes stronger and stronger and finally leads to fire. The limit temperatures for the occurrence of such a thermal runaway are known for the various types of regular batteries and rechargeable batteries, and the choice of a suitable substance that releases carbon dioxide for storage in the container 14 can be made individually for each type of battery and/or rechargeable battery as a function of the temperature of decomposition of the substance.

The temperature range of the carbon dioxide release by a substance stored in the container is selected such that a significant release of carbon dioxide essentially cannot take place in the range of the normal operating temperature of the device for generating electrical or mechanical energy. Moreover, the encapsulation 12 or the container 14 may have an adapted thermal insulation, which prevents the release of carbon dioxide during normal operation.

A further possible of initiating the release of a flame-retardant component from the substance stored in the container 14 is to provide a detector, preferably inside the encapsulation 12, that detects the conflagration gases or the temperature prevailing inside the encapsulation 12 and/or the pressure prevailing there and sends it to a control unit. Then, if the minimum concentration of a conflagration gas or a temperature limit is exceeded, the control unit can initiate the release of flame-retardant components from the substance stored in the container 14, for instance by means of a heating device inside the container 14. Simultaneously, such an arrangement also makes it possible to inform the user of the device that a fire has been prevented or extinguished, because he is informed of the existence of conflagration gases, the exceeding of a temperature limit, or the exceeding of the pressure level in the container 14.

If sodium hydrogen carbonate, for instance, is used as the substance stored in the container, it decomposes into sodium hydroxide and carbon dioxide above 87° C. From one mol (84 g) of sodium hydrogen carbonate, thermal decomposition causes the formation of 22.4 l of carbon dioxide. In this way, the appropriate amount of sodium hydrogen carbonate can easily be adapted to the internal volume of the encapsulation 12. To make positive displacement of the oxygen from the air contained in the encapsulation 12 easier, the encapsulation 12 can also have an overpressure valve. In general, compounds that are suitable as the substance stored in the container are those that release carbon dioxide above a temperature range of from 100 to 180° C., and in particular above 130 to 150° C.

A further embodiment of the present invention is shown in FIG. 2. In it, the container 14 is positioned inside the encapsulation 12. It is in fluidic contact with the interior of the encapsulation 12, for instance via a metering valve 16 or a bursting disk. This embodiment is advantageous particularly in applications in which the device for generating or storing electrical or mechanical energy includes an internal combustion engine. The container 14 in that case can be mounted inside the engine encapsulation, and either one central container 14 or a plurality of containers are provided, which are positioned particularly at the locations of an engine where there is an increased risk of fire, such as the vicinity of the pistons or the cylinder head seals. The possibility also exists in the event of fire of putting the container 14 into contact not only with the air space provided inside the encapsulation 14 but additionally or alternatively to introduce the substance stored in the container 14 into the engine itself as well, for instance via the injection valves provided on the engine.

The use of such a flame-retardant system can be done in general in devices for generating or storing electrical or mechanical energy for mobile, stationary or portable applications. The prerequisite is that a suitable energy storage means and/or energy converter be located in a closed-off compartment, for instance in the form of an encapsulation.

The foregoing relates to preferred exemplary embodiments of the invention, it being understood that other variants and embodiments thereof are possible within the spirit and scope of the invention, the latter being defined by the appended claims.

We claim:

1. A device for generating or storing electrical or mechanical energy, having an encapsulation in which at least one element of the device serving to generate or store electrical or mechanical energy, or a fuel tank, is positioned, and having a container for a flame-retardant substance, wherein the substance stored in the container releases a flame-retardant component if needed.

2. The device as defined by claim 1, wherein the released flame-retardant component is gaseous.

3. The device as defined by claim 1, wherein the flame-retardant component is released upon an increase of pressure or temperature.

4. The device as defined by claim 2, wherein the flame-retardant component is released upon an increase of pressure or temperature.

5. The device as defined by claim 1, wherein the substance that releases a flame-retardant component is a hydrogen carbonate, a triazine, or an azide.

6. The device as defined by claim 2, wherein the substance that releases a flame-retardant component is a hydrogen carbonate, a triazine, or an azide.

7. The device as defined by claim 3, wherein the substance that releases a flame-retardant component is a hydrogen carbonate, a triazine, or an azide.

8. The device as defined by claim 1, wherein the substance releasing a flame-retardant component is solid or liquid carbon dioxide or liquid nitrogen.

9. The device as defined by claim 2, wherein the substance releasing a flame-retardant component is solid or liquid carbon dioxide or liquid nitrogen.

10. The device as defined by claim 3, wherein the substance releasing a flame-retardant component is solid or liquid carbon dioxide or liquid nitrogen.

11. The device as defined by claim 8, wherein the substance releasing a flame-retardant component is formed of microcapsules, filled with carbon dioxide or nitrogen.

12. The device as defined by claim 1, wherein the container includes a bursting disk that is in contact with the interior of the encapsulation.

13. The device as defined by claim 8, wherein the container includes a bursting disk that is in contact with the interior of the encapsulation.

14. The device as defined by claim 1, wherein the container is in contact with the interior of the encapsulation via a metering valve.

15. The device as defined by claim 1, wherein a sensor for detecting conflagration gases or a temperature is provided.

16. The device as defined by claim 1, wherein the container is integrated with the encapsulation.

17. The device as defined by claim 1, wherein the container includes a heating means.

18. The device as defined by claim 1, wherein the element serving to generate or store electrical or mechanical energy is a fuel cell, an internal combustion engine, or a rechargeable battery.

19. A method for fire avoidance in a device for generating or storing electrical or mechanical energy, as defined by claim 1, wherein an encapsulation, in which at least one element serving to generate or store electrical or mechanical energy is put into fluidic contact with a container for a flame-retardant substance, and the substance stored in the container releases a flame-retardant component if needed.

20. The method as defined by claim 13, wherein the release of the flame-retardant component is effected as soon as a conflagration gas is detected or a limit temperature is exceeded.
